(19) United States
(12) Patent Application Publication
(10) Pub. No.: US 2011/0009093 A1
(43) Pub. Date: Jan. 13, 2011

(54) ASYNCHRONOUS VOICE AND/OR VIDEO COMMUNICATION SYSTEM AND METHOD USING WIRELESS DEVICES

(76) Inventors: Michael Self, Fort Lauderdale, FL (US); Rayond Penn, Davie, FL (US)

Correspondence Address: ROBERT M. SCHWARTZ, P.A., P.O. BOX 221470, HOLLYWOOD, FL, 33022, US

(21) Appl. No.: 12/834,527

(22) Filed: Jul. 12, 2010

Related U.S. Application Data
(60) Provisional application No. 61/224,972, filed on Jul. 13, 2009.

(51) Int. Cl. H04W 4/12; H04W 12/06

(52) U.S. Cl. 455/411; 455/413

(57) ABSTRACT

A system and method are provided a voice and/or video message asynchronously in a PTT network. The voice and/or video message is stored and an informational message is provided to a recipient device to assist in playing back the stored voice and/or video message at the recipient device.

### CROSS-REFERENCE TO RELATED APPLICATIONS

The present application claims priority to: co-pending Provisional Patent Application No. 61/224,972, filed on Jul. 13, 2009 and entitled “Asynchronous Voice Communication System And Method Using Wireless Devices”, that application being incorporated herein, by reference, in its entirety.

### BACKGROUND OF THE INVENTION

1. Field of the Invention

The invention relates to a system and method for providing asynchronous voice and/or video communication using wireless devices.

2. Description of the Related Art

Synchronous push-to-talk (PTT) systems, including synchronous push-to-talk-over-cellular (PoC) systems, are known. In such systems, a subscriber is permitted to instantly contact another subscriber who has been selected from a list of online contacts. Such systems have additionally permitted a subscriber to contact ad-hoc groups with one or more online contacts selected from a contact list.

U.S. Patent Application Publication No. 2008/0062373 to Lessing (“the '373 application”), published on Mar. 13, 2008, discloses a method and communication system for transferring messages containing audio and/or voice information which, depending on a setting of the receiving communication terminal, can either be directly played back or temporarily stored for play back at a later time point. In the '373 application, messages are preferably transmitted as a PTT message with the user of the receiving communication terminal pre-determining whether the communication is direct or asynchronous.

What is needed is a PTT system wherein the sender provides an audio and/or video message that can be stored for later play back.

### SUMMARY OF THE INVENTION

It is accordingly an object of the invention to provide a push-to-talk system and method for providing an indication to a receiving wireless device that an audio and/or video message is stored and can be played back.

Other features which are considered as characteristic for the invention are set forth in the appended claims.

Although the invention is illustrated and described herein as embodied in an Asynchronous Voice and/or Video Communication System And Method Using Wireless Devices, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

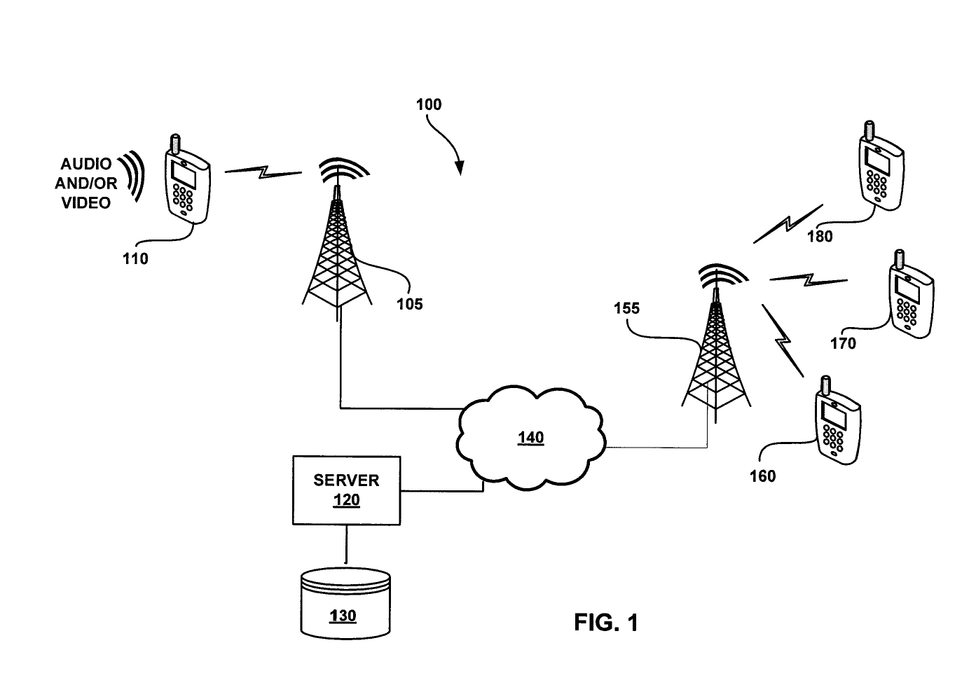

The present invention is illustrated by way of example, and not by way of limitation, in the accompanying drawing, FIG. 1, which shows a simplified diagram of a system in accordance with one particular embodiment of the instant invention.

### DESCRIPTION OF THE PREFERRED EMBODIMENTS

Referring now to FIG. 1, there is shown a simplified diagram of a system 100 for providing asynchronous voice and/or video communications between wireless devices. In the system 100, a voice or audio and/or video message intended for a recipient is communicated into a wireless device or handset 110, which can be a push-to-talk device, such as a push-to-talk cellular phone as presently offered by such providers as NEXTEL, VERIZON, etc. However, in accordance with the instant application, the sender may select that, instead of the audio and/or video message being instantly communicated to the intended recipient, that the message instead be transmitted and stored as an audio and/or video file for later retrieval by the recipient.

For example, a sender using a PTT wireless device 110 records an audio and/or video message that is to be received by at least one of the wireless devices 160, 170 180. The sender selects the intended recipients from a list displayed on the device 110. If desired, the audio and/or video message can be intended for one, all or a subset of the wireless devices 160, 170, 180 selected from a list of contacts and/or contact groups stored in the device 110.

After selecting the intended recipient(s), the sender records a voice message by pressing the PTT button on the wireless device 110 (usually located on the side of the wireless device 110). Upon releasing the PTT button, the message is transmitted from the wireless device 110 to a server 120, via a cell tower and a data network, such as the Internet or a WAN or even another type of data network.

The voice and/or video message received from the device 110 is stored as an audio file (such as an MP3 formatted audio file) and/or video file (such as an MPEG audio/video file or a Quicktime file) in a database 130 by the server 120. Upon storing the voice and/or video message, the server 120 sends a textual message to the intended recipient(s), informing them of a stored voice and/or video message. For example, the server 120 can transmit an SMS message, text message and/or an email to the intended recipient(s) informing them of the stored voice message. In one particularly preferred embodiment of the instant invention, the server 120 broadcasts/multicasts an SMS message to the intended recipient(s), via the data network 140 and wireless transmission system (i.e., cell tower and/or cell network) 155 presently communicating with each recipient wireless device. Note that, if the voice/video message is intended for only one recipient, only one SMS is broadcast. If the voice/video message is intended for a plurality of recipients, the SMS message is multicast to the devices of the plurality of recipients.

In the instant embodiment, the transmitted SMS message(s) does not contain the stored audio and/or video file(s). Rather, in the presently described embodiment, the SMS message includes a hyperlink directing the wireless device to the server 120, via the data network 140, to retrieve and play the stored audio and/or video file(s).

As such, in the instant invention, the sender, and not the recipient controls whether the PTT message is real-time or asynchronous. Thus, the storage of an audio and/or video file does not require any pre-programming or foreknowledge on the part of the recipient. Further, because the audio/video message is stored on the server 120, rather than on the recipient handset, there is no need for software installed on the handset to receive and process the asynchronous audio/video message.

The instant invention has distinct advantages in the context of messaging and social networking. A sender can transmit an audio and/or video message to one or more recipient wireless devices or handsets 160, 170, 180, simultaneously, and await a response at the convenience of the recipient. For purposes of explanation only, the following example is given, however, such example is not meant limit the invention thereto.

### Example 1

Joe, a dedicated philatelist, wants to invite a group of similarly interested people to a stamp club meeting at his home on the following Tuesday evening. Using his PTT cellular phone, Joe selects an entry in his contact list entitled “Stamp Enthusiasts”, which Joe has previously designated to include Sam, Pete and Joan, via their cell phones 160, 170, 180, respectively. Joe pushes the PTT button, connecting his phone 110 to the cellular network 105 and, via a data network 140, to the server 120. With the PTT button pushed, Joe transmits, as an audio and/or video message, the following message to the server 120:

“Please join me at my home next Tuesday, at 7:00 pm for an evening of fun-filled stamp discussions and refreshments. Please RSVP by Monday night, if you can come.”

Upon releasing the PTT button, Joe's voice/video message is stored as an audio file (such as an MP3 audio file) and/or a video file at the server 120. The server 120 then formulates an SMS message, which it multicasts to the devices 160, 170 and 180 of Sam, Pete and Joan, via the data network 140 and cellular network 155. Alternately, the server 120 can transmit the messages directly over the cellular network 155, if it has that capability.

Each of the devices 160, 170, 180 receives the SMS message and indicates the same, in the manner set by the user. Whenever convenient for them, the recipients Sam, Pete and Joan pull up the SMS message and activate a hyperlink contained therein, which connects the devices 160, 170, 180 to the server 120 over the cell network 155 and/or data network 140 and plays the stored audio/video message from Joe. For example, Sam receives the SMS message and instantaneously selects the hyperlink to replay the audio/video message. Pete and Joan, however, were unavailable at the moment the SMS message came in, but were able to retrieve the message and listen to, and/or view, the audio/video message at later, more convenient times.

As can be seen from the foregoing example, the system of the instant invention provides a simple and convenient system for providing messages that permit asynchronous retrieval and response using a PTT system.

It is noted that there may exist variations of the foregoing example. For example, the aforementioned notification SMS message (or other signal meant to notify the recipient of the existence of the stored audio message) need not be initiated by the server 120; instead it may be initiated by the phone 110 and sent directly to one or more of phones 160, 170 and/or 180.

Further, transmission of the message from phone 110 to server 120 may occur in real-time, where the audio and/or video is streamed directly to the server as it is spoken/captured, or it may occur in non-real-time where the audio and/or video data are captured and stored on the phone 110 and then uploaded to the server 120 at some later time. Such a feature would allow, for example, Joe to record his audio/video message and then decide he did not like it and record it again before deciding to upload the audio/video message to the server 120. In another example, perhaps Joe is on an airplane, or otherwise without communications capabilities via the phone 110, and would like to send a plurality of audio/video messages to a plurality of recipients and/or recipient groups. Joe need only push the PTT button on phone 110 for each audio/video message and speak his message into the phone to record and store a plurality of audio/video messages in the phone 110. Once Joe has arrived at his destination and/or the phone 110 again has communications capabilities, phone 110 will upload all of the pre-recorded audio and/or video messages to server 120.

Note that, in the instant invention, the identifying hyperlink to the audio and/or video message need not be limited to the recipients chosen by the message creator, nor shall the hyperlink be limited to devices 160, 170 and 180. By way of example, perhaps Pete would like to invite some of his friends to the Monday night meeting without Joe's knowledge. Pete may forward the hyperlink to his friends through SMS or other signaling method. Once received by Pete's friends, each of them may invoke the hyperlink at their convenience and be allowed access to the audio and/or video message stored on server 120 that was recorded by Joe.

If desired, in one particular embodiment of the invention, further enhancements and/or restrictions may be applied to the subject audio and/or video message stored on server 120, such that only authorized users may listen to the audio message. For example, access to the audio/video message(s) can be limited, to users and/or devices specified by Joe, in the foregoing example. In such a case, Pete may be able to forward the hyperlink to his friends, but his friends will be disallowed access to the audio and/or video message due to the security constraints imposed by Joe upon creation of the audio and/or video message.

Note that the above-described embodiments are exemplary and that the above invention is not meant to be limited only to its preferred embodiments. It can be seen that other modifications can be made to the preferred embodiments and still be within the spirit of the present invention.

I claim:

1. A system for communicating a voice and/or video message asynchronously to a wireless device, comprising:
a push-to-talk (PTT) transmitting device for transmitting the voice and/or video message;
a server in communication with the PTT transmitting device for receiving the transmitted voice and/or video message and storing the voice and/or video message as an audio file and/or a video file;
the system being programmed to transmit a message to the wireless device with textual information related to the stored audio and/or video file(s), said textual information including information used by the wireless device to access the audio and/or video file(s) stored on the server.

2. The system of claim 1, wherein the message is transmitted to the wireless device by the PTT transmitting device.

3. The system of claim 1, wherein the message is transmitted to the wireless device by the server.

4. The system of claim 1, wherein the textual information includes a hyperlink to the stored audio and/or video file(s) on the server.

5. The system of claim 4, wherein actuation of the hyperlink on the wireless device provides access to the stored audio and/or video file(s) by the wireless device.

6. The system of claim 3, wherein said server is programmed to transmit a message to a plurality of wireless devices with textual information related to the stored audio and/or video file(s).

7. The system of claim 6, wherein the textual information transmitted to each of the plurality of wireless devices includes a hyperlink to the stored audio and/or video file(s) on the server.

8. The system of claim 1, wherein the message is transmitted as at least one of: an SMS message, a text message and an email

9. The system of claim 1, wherein a plurality of voice and/or video messages can be generated using the PTT transmitting device and stored in the PTT transmitting device prior to the plurality of messages being uploaded to the server.

10. The system of claim 1, wherein the PTT transmitting device connects to the server to store the voice and/or video message on the server in real-time.

11. The system of claim 1, wherein the server is configured to check whether the wireless device is authorized to access the stored audio and/or video file(s) prior to the wireless device accessing and/or retrieving the stored audio and/or video file(s).

12. A method of storing a voice and/or video message, comprising the steps of:
generating a voice and/or video message with a push-to-talk (PTT) transmitting device;
transmitting the voice and/or video message from the PTT transmitting device to a server;
storing the transmitted voice and/or video message as an audio and/or video file(s) on the server; and
at least one of the server and the PTT transmitting device being configured to transmit a message to a wireless device with textual information related to the stored audio and/or video file(s), the textual information including information usable by the wireless device to access the audio and/or video file(s) stored on the server.

13. The method of claim 12, wherein the textual information includes a hyperlink to the stored audio and/or video file(s) on the server.

14. The method of claim 12, wherein the server is programmed to transmit a message to a plurality of wireless devices with textual information related to the stored audio and/or video file(s).

15. The method of claim 14, wherein the textual information transmitted to each of the plurality of wireless devices includes a hyperlink to the stored audio and/or video file(s) on the server.

16. The method of claim 12, wherein the message is transmitted as at least one of: an SMS message, a text message and an email.

17. The method of claim 16, wherein the message is transmitted to the wireless device by the server.

18. The method of claim 16, wherein the message is transmitted to the wireless device by the PTT transmitting device.

19. The method of claim 12, wherein a plurality of voice and/or video messages can be generated using the PTT transmitting device and stored in the PTT transmitting device prior to the plurality of messages being uploaded to the server.

20. A method for storing a voice and/or video message, comprising the steps of:
receiving, by a server, a voice and/or video message from a push-to-talk (PTT) transmitting device;
storing the voice and/or video message as an audio file and/or video file in the server;
after storing the voice and/or video message, transmitting a message to at least one wireless device with textual information related to the stored audio and/or video file(s), the textual information including information usable by the wireless device to access the audio and/or video file(s) stored on the server; and
the transmitted message being at least one of:
an SMS message;
a text message; and
an email.
